(19) United States
(12) Patent Application Publication
(10) Pub. No.: US 2016/0219242 A1
(43) Pub. Date: Jul. 28, 2016

(54) TELEMATICS SYSTEM, VEHICLE AND METHOD

(71) Applicant: National Central University, TAOYUAN CITY (TW)

(72) Inventors: Chih-Lin HU, TAIPEI CITY (TW); Shih-Kai WANG, Chiayi City (TW); Tzu-Ting TSENG, Taoyuan City (TW); Ming-Ying LU, Taoyuan City (TW)

(21) Appl. No.: 14/708,308

(22) Filed: May 11, 2015

(30) Foreign Application Priority Data
Jan. 22, 2015 (TW) 104102134

(51) Int. Cl. H04N 5/44; G06F 17/30; B60R 1/00

(52) U.S. Cl. CPC H04N 5/44; B60R 1/00; G06F 17/3028

(57) ABSTRACT

A vehicle equipped with a telematics technology is provided. The vehicle includes a communication module, a display module, a processing module and an input module. The communication module receives information packets that include vehicle data and service data from a plurality of image-delivering vehicles. The processing module retrieves the information packets from the communication module to control the display module to display the vehicle information of each of the image-delivering vehicles accordingly. The input module receives a selection input. The processing module selects at least one of the image-delivering vehicles to wirelessly connect to a selected image-delivering vehicle and retrieves event-recording image therefrom to display the event-recording image on the display module.

### RELATED APPLICATIONS

This application claims priority to Taiwanese Application Serial Number 104102134, filed Jan. 22, 2015, which is herein incorporated by reference.

### BACKGROUND

1. Field of Invention

The present invention relates to a telematics technology. More particularly, the present invention relates to a telematics system, vehicle and method of the same.

2. Description of Related Art

In order to improve the safety of driving, the event-recording device is either built in or externally connected to various vehicles, whether they are used or new. The event-recording devices record the images of the front or the neighboring area of the driven vehicles. Once an accident occurs, the event-recording images are used as a direct evidence to clarify the truth.

However, the data of the event-recording image is only stored in the event-recording device or other modules in the vehicle since always. In other words, the recording of the event is only used to assist the owner of the corresponding vehicle reserved to provide self-protection. No further usage is provided by the event-recording image.

Accordingly, what is needed is a telematics communication system vehicle and method of the same to make more use of the event-recording images.

### SUMMARY

An aspect of the present invention is to provide a vehicle equipped with a telematics technology. The vehicle includes a communication module, a display module, a processing module and an input module. The communication module receives information packets that include vehicle data and service data from a plurality of image-delivering vehicles. The processing module is electrically connected to the communication module and the display module to retrieve the information packets from the communication module to control the display module to display vehicle information of each of the image-delivering vehicles accordingly. The input module is electrically connected to the processing module to receive a selection input. The processing module selects at least one of the image-delivering vehicles according to the selection input to be wirelessly connected to a selected image-delivering vehicle and retrieves an event-recording image from the selected image-delivering vehicle to display the event-recording image on the display module.

Another aspect of the present invention is to provide a telematics communication method used in a vehicle equipped with a telematics technology. The telematics communication method includes the steps outlined below. Information packets that include vehicle data and service data are received from a plurality of image-delivering vehicles by a communication module. The information packets are retrieved from the communication module by a processing module to control a display module to display vehicle information of each of the image-delivering vehicles accordingly. A selection input is retrieved by an input module. At least one of the image-delivering vehicles is selected by the processing module according to the selection input to be wirelessly connected to a selected image-delivering vehicle. An event-recording image is retrieved from the selected image-delivering vehicle to display the event-recording image on the display module.

Yet another aspect of the present invention is to provide a telematics communication system. The telematics communication system includes a plurality of image-delivering vehicles and an image-receiving vehicle. The image-delivering vehicles broadcast information packets and perform image-retrieving to generate an event-recording image, wherein the information packets include vehicle data and service data. The image-receiving vehicle includes a communication module, a display module, a processing module and an input module. The communication module receives information packets that include vehicle data and service data from the image-delivering vehicles. The processing module is electrically connected to the communication module and the display module to retrieve the information packets from the communication module to control the display module to display vehicle information of each of the image-delivering vehicles accordingly. The input module is electrically connected to the processing module to receive a selection input. The processing module selects at least one of the image-delivering vehicles according to the selection input to be wirelessly connected to a selected image-delivering vehicle and retrieves an event-recording image from the selected image-delivering vehicle to display the event-recording image on the display module.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a diagram of a telematics communication system in an embodiment of the present invention;

FIG. 2 is a block diagram of the image-delivering vehicle in an embodiment of the present invention;

FIG. 3 is a block diagram of the image-receiving vehicle in an embodiment of the present invention;

FIG. 4 is a display frame generated by the display module of the image-receiving vehicle in an embodiment of the present invention;

FIG. 5A to FIG. 5C are diagrams of the display frame generated by the display module of the image-receiving vehicle in various embodiments of the present invention; and

FIG. 6 is a flow chart of a telematics communication method in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

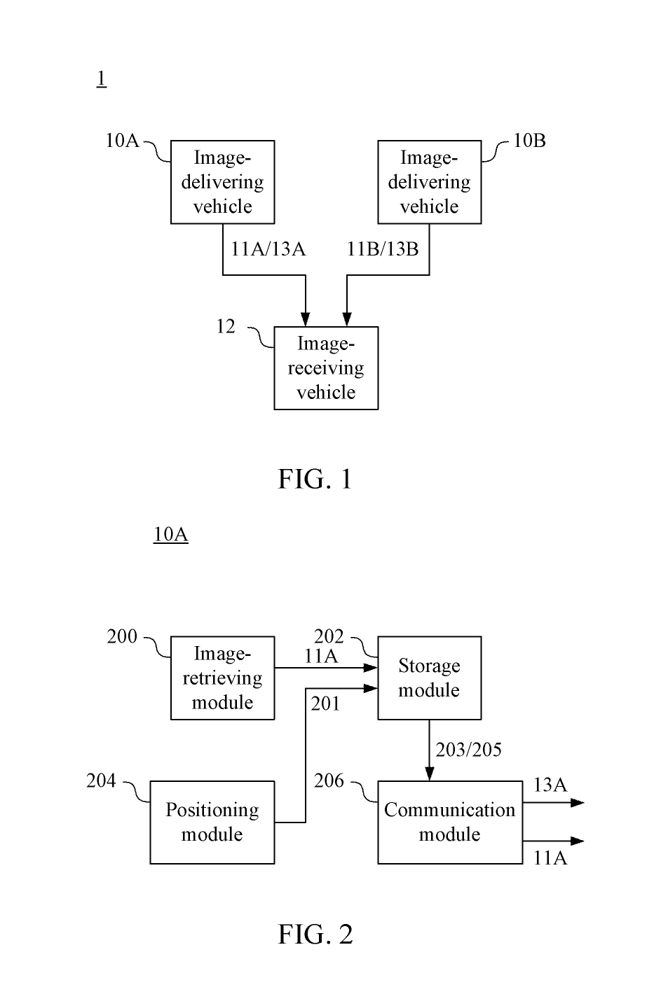

FIG. 1 is a diagram of a telematics communication system 1 in an embodiment of the present invention. The telematics communication system 1 includes image-delivering vehicles 10A, 10B and an image-receiving vehicle 12.

The image-delivering vehicles 10A and 10B perform image-retrieving to generate event-recording images 11A and 11B respectively to record the instant image on the basis of the neighboring environment of the image-delivering vehicles 10A and 10B. The image-delivering vehicles 10A and 10B further broadcast information packets 13A and 13B related thereto such that the image-receiving vehicle 12 receives the information packets 13A and 13B. The image-delivering vehicles 10A and 10B further perform data transmission based on a selection of the user of the image-receiving vehicle 12 such that the image-receiving vehicle 12 retrieves the event-recording image 11A and/or the event-recording image 11B.

It is appreciated that the number of the image-delivering vehicles 10A and 10B illustrated in FIG. 1 can be different according to practical applications and is not limited thereto. A detail description of the operation and the configuration of the telematics communication system 1 are made in the following paragraphs.

FIG. 2 is a block diagram of the image-delivering vehicle 10A in an embodiment of the present invention. The image-delivering vehicle 10A includes an image-retrieving module 200, a storage module 202, a positioning module 204 and a communication module 206.

The image-retrieving module 200 performs image-retrieving to generate the event-recording image 11A and stores the event-recording image 11A in the storage module 202. In different embodiments, the event-recording image 11A can be stored by using different file formats. The positioning module 204 generates a position coordinate 201 of the image-delivering vehicle 10A and stores the position coordinate 201 in the storage module 202. In an embodiment, the positioning module 204 is a global positioning system (GPS) to generate a global position coordinate of the image-delivering vehicle 10A.

The communication module 206 broadcasts the information packet 13A. In an embodiment, the communication module 206 activates such as, but not limited to a WiFi communication port such that the image-delivering vehicle 10A becomes a wireless WiFi access point (AP). Through the broadcast of the information packet 13A, other vehicles equipped with the wireless data transmission ability, such as the image-receiving vehicle 12, can detect the existence of the wireless access point and further perform the wireless communication.

In an embodiment, the communication module 206 broadcasts the information packet 13A through a default broadcast or multicast internet protocol frequency band under an internet protocol (IP) mode. In another embodiment, the communication module 206 broadcasts the information packet 13A through a default communication media, such as but not limited to a media implemented by using the dedicated short-range communication (DSRC) technology. For example, the communication module 206 broadcasts the information packet 13A under an AD HOC mode, a WiFi direct mode or one of the other non internet protocol modes.

In an embodiment, the information packet 13A includes a vehicle data 203 and a service data 205. The vehicle data 203 and the service data 205 are stored in the storage module 202. The communication module 206 can retrieve and broadcast the vehicle data 203 and the service data 205 stored in the storage module 202. The vehicle data 203 may include such as, but not limited to an identification code and a position coordinate 201 of the image-delivering vehicle 10A, wherein the position coordinate 201 is generated by the positioning module 204. The identification code can be such as, but not limited to the identification number of the image-delivering vehicle 10A.

The service data 205 includes a service type, a service name, a service code, a service description string, a descriptive file source URL or a combination of the above of the image-delivering vehicle 10A. The service type, the service name and the service code can be such as, but not limited to the image stream transmission method supported by the communication module 206. The content of the service description string includes such as, but not limited to a network transmission access location, supported image output formats, supported transmission protocols and additional sub-services. The network transmission access location is the address of the event-recording image 11A in the storage module 202. Other external modules can retrieve the event-recording image 11A in the storage module 202 through the communication module 206 after the configuration set by using the information described above.

Besides, the descriptive file source URL is used to store the URL of the descriptive file (not illustrated) that includes the service description string. Other external modules can open the descriptive file through the URL, read out the service description string, perform setting by using the content thereof and retrieve the event-recording image 11A stored in the storage module 202 through the communication module 206. It is appreciated that in the practical implementation, the service data 205 may only include one of the service description string and the descriptive file source URL.

In an embodiment, the service data 205 may further selectively include a community code and a data visibility. The community code can be a code of an application program. In other words, the specific application program having the code is used as a communication platform between the image-delivering vehicle 10A and the image-receiving vehicle 12. The data visibility is used to set the publicity, privacy and the condition parameters of the data.

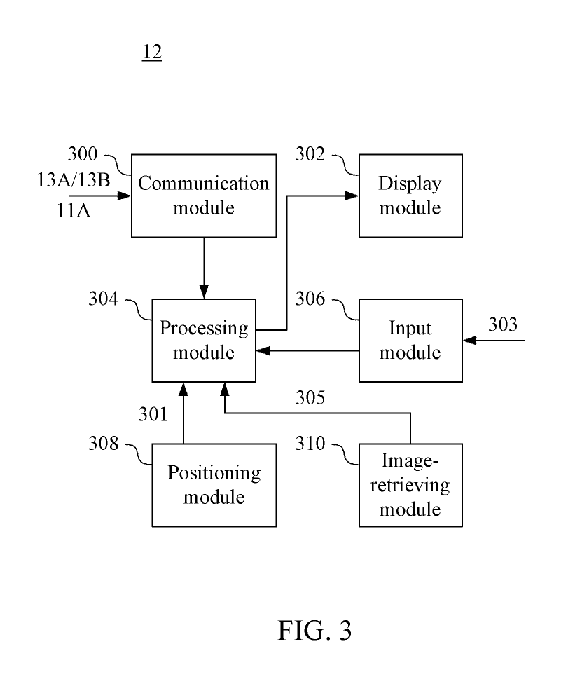

FIG. 3 is a block diagram of the image-receiving vehicle 12 in an embodiment of the present invention. The image-receiving vehicle 12 includes a communication module 300, a display module 302, a processing module 304 and an input module 306.

The communication module 300 keeps detecting the broadcast information in the neighboring area to detect whether a vehicle that acts as wireless access points exists. In other words, the communication module 300 determines whether there is a vehicle that would like to share the event-recording images thereof. For example, after receiving the information packets 13A and 13B by using the communication module 300, the image-receiving vehicle 12 determines that the image-delivering vehicles 10A and 10B are the vehicles being able to share their event-recording images. As described above, the communication module 300 can receive the information packets 13A and 13B under the AD HOC mode, the WiFi direct mode or one of the other non internet protocol modes.

The processing module 304 is electrically connected to the communication module 300 and the display module 302 to retrieve the information packets 13A and 13B from the communication module 300 to control the display module 302 to display vehicle information of each of the image-delivering vehicles 10A and 10B accordingly. In an embodiment, the vehicle information includes the identification code of the image-delivering vehicles 10A and 10B.

In an embodiment, the image-receiving vehicle 12 further includes a positioning module 308 to generate a self position coordinate 301 of the image-receiving vehicle 12. The processing module 304 controls the display module 302 to display the vehicle information according to the identification code of the image-delivering vehicles 10A and 10B, the position coordinate and the self position coordinate 301 of the image-receiving vehicle 12. Accordingly, in an embodiment, the vehicle information includes the relative positions of the image-delivering vehicles 10A and 10B relative to the image-receiving vehicle 12.

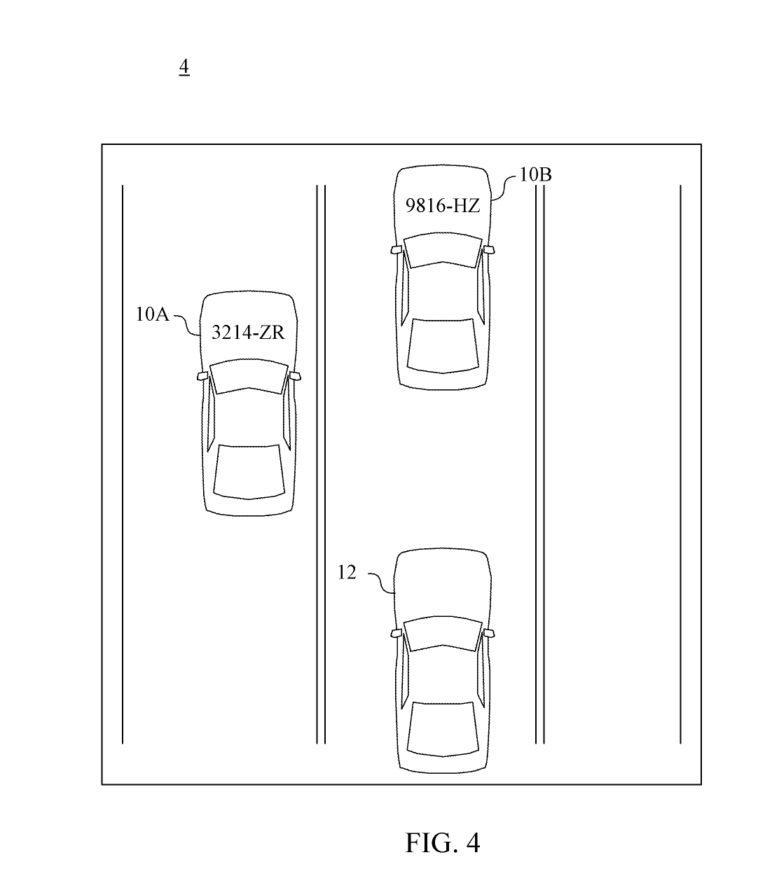

FIG. 4 is a display frame 4 generated by the display module 302 of the image-receiving vehicle 12 in an embodiment of the present invention.

In an embodiment, the processing module 304 controls the display module 302 to display the vehicle information in the display frame 4. For example, as illustrated in FIG. 4, the image-delivering vehicle 10A is located at the left front side of the image-receiving vehicle 12 and has an identification number of 3124-ZR. The image-delivering vehicle 10B is located at the front side of the image-receiving vehicle 12 and has an identification number of 9816-HZ. The relative positions of the image-delivering vehicles 10A and 10B relative to the image-receiving vehicle 12 are generated according to the position coordinates thereof. The identification numbers are generated according to the identification codes thereof.

It is appreciated that the display frame 4 described above is merely an example. In other embodiments, the information of the image-delivering vehicles 10A and 10B can be displayed by using simple diagrams or texts. The display of the information is not limited to the display frame 4 illustrated in FIG. 4.

The input module 306 is electrically connected to the processing module 304 to receive a selection input 303. The processing module 304 selects at least one of the image-delivering vehicles 10A and 10B according to the selection input 303.

In an embodiment, the input module 306 is a speech recognition module to receive a speech selection input to perform a recognition process and obtain the selection input 303 after the recognition process. The processing module 304 further performs the selection based on the recognized speech selection input. For example, the user may speak “3214-ZR” as the selection input 303 of the input module 306. The processing module 304 selects the image-delivering vehicle 10A based on the recognition result.

In another embodiment, the input module 306 and the display module 302 are integrated into a touch display module to receive a touch selection input as the selection input 303. For example, the user may touch and press the image-delivering vehicle 10A labeled as “3214-ZR” displayed in the display frame 4 of the display module 302 such that the processing module 304 selects the image-delivering vehicle 10A.

The processing module 304 is further wirelessly connected to the selected image-delivering vehicle 10A and retrieves the event-recording image 11A from the selected image-delivering vehicle 10A. As described above, the processing module 304 retrieves the service description string included in the service data 205 of the information packet 13A, or retrieves the descriptive file from the image-delivering vehicle 10A according to the descriptive file source URL. Further, the processing module 304 performs a coordination process to coordinate an image reception and transmission mode according to a content of the service description string or the descriptive file.

In an embodiment, the coordination process includes analysis, comparison and matching process to obtain a set of appropriate image reception and transmission mode, including such as, but not limited to the image output format and the transmission protocol. Moreover, the coordination process is performed either automatically or manually by the user. In some embodiments, the image-receiving vehicle 12 reversely contacts the image-delivering vehicle 10A during the coordination process. For example, when the image resolution supported by the modules in the image-receiving vehicle 12 is lower than the image resolution supported by the modules in the image-delivering vehicle 10A, the image-receiving vehicle 12 sends the request to the image-delivering vehicle 10A to demand an image having a lower quality. The image-delivering vehicle 10A can perform a transformation of the format of the image or lower the resolution of the image.

The processing module 304 further establishes a network connection according to the coordinated image reception and transmission mode to retrieve the event-recording image 11A from the selected image-delivering vehicle 10A. In an embodiment, in the beginning of the establishment of the connection, the processing module 304 feedbacks the related information to the image-delivering vehicle 10A through the communication module 300, such as but not limited to the ability to support the image resolution. The subsequent data transmission is performed after a further coordination based on the feedback information.

The processing module 304 further controls the display module 302 to display the event-recording image 11A thereon. In an embodiment, the processing module 304 controls the display module 302 to solely display the event-recording image 11A. In another embodiment, the processing module 304 further includes a self image-retrieving module 310 to perform image-retrieving and generates a self event-recording image 305. The processing module 304 controls the display module 302 to simultaneously display the event-recording image 11A and the self event-recording image 305.

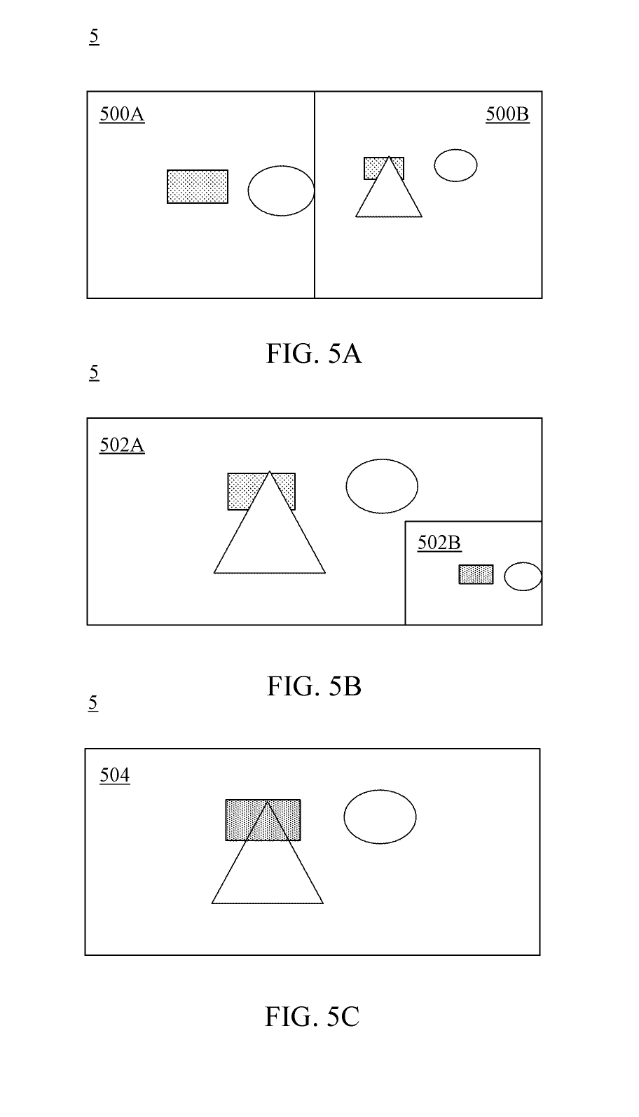

FIG. 5A to FIG. 5C are diagrams of the display frame 5 generated by the display module 302 of the image-receiving vehicle 12 in various embodiments of the present invention.

The processing module 304 controls the display module 302 to display the image in different formats. In an embodiment, as illustrated in FIG. 5A, the display module 302 displays the event-recording image 11A and the self event-recording image 305 by using two independent frames 500A and 500B respectively. In another embodiment, as illustrated in FIG. 5B, the display module 302 displays the images in a picture in picture form such that a main frame 502A and a sub frame 502B are used to display the event-recording image 11A and the self event-recording image 305 respectively. Further, in an embodiment, the content of the main frame and the sub frame can be swapped to accomplish a more elastic display mechanism. In yet another embodiment, as illustrated in FIG. 5C, the display module 302 can display a mixed frame 504 to mix the event-recording image 11A and the self event-recording image 305 into a single frame after the calculation of the processing module 304.

It is appreciated that in the above embodiments, only one selected image-delivering vehicle 10A is used as the example. In other embodiments, the event-recording images of a multiple of image-delivering vehicles can be retrieved according to the selection of the user and be displayed on the display module 302 simultaneously.

FIG. 3 is a flow chart of a method 300 for aiding breathing in an embodiment of the present invention. The method 300 is used in the system 1 for aiding breathing illustrated in FIG. 1 and FIG. 2. The method 300 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

As a result, the advantage of the present invention is to use the vehicle equipped with the telematics technology to receive event-recording image from the image-delivering vehicle in the telematics communication system. Even the sight of the driver is blocked, the instant image of the neighboring scene can be perceived according to the shared image. The safety of the vehicle driving is improved. It is appreciated that in the above embodiments, the image-delivering vehicles 10A, 10B and the image-receiving vehicle 12 are independent. In practical application, a single vehicle can be the image-delivering vehicle and the image-receiving vehicle at the same time such that the vehicle can share the event-recording image thereof with other vehicles and receive the event-recording images from other vehicles as well. Further, the system and module described above can be applied to various kind of vehicles, such as cars, motorcycles and other mass transportation device and are not limited to the description and the related diagrams shown in the above examples.

In step 301, the body displacement 11 of the target 2 is detected by a breathing detection device 10 of the system 2 for aiding breathing, wherein the body displacement 11 corresponds to the breathing of the target 2.

In step 302, the breathing sound 15 of the target 2 is detected by the sound-receiving device 12 of the system 1 for aiding breathing.

In step 303, the breathing condition of the target 2 is determined by the processing device 16 of the system 1 for aiding breathing according to the body displacement 11.

In step 304, whether the sleep apnea condition of the target 2 occurs is determined by the processing device 16 according to the breathing condition and the breathing sound 15 based on the stored algorithm.

When the sleep apnea condition of the target 2 does not occur, the flow goes back to the step 301 to keep detecting.

When the sleep apnea condition occurs, the processing device 16 control the airflow providing device 14 of the system 1 for aiding breathing to generate the airflow 17 to the respiratory apparatus of the target 2 in step 305.

Reference is now made to FIG. 4 together with FIG. 1. FIG. 4 is a diagram of the components of the system 1 for aiding breathing and the target 2 in an embodiment of the present invention.

As described in the previous embodiment, the breathing detection device 10, the sound-receiving device 12 and the processing device 16 are integrated in a composite device 20. As a result, the detail is not further described herein.

In the present embodiment, the airflow supplying device 14 illustrated in FIG. 1 includes the air supplying mask 140, the air supplying device 142 and a valve 144, as illustrated in FIG. 4. The air supplying mask 140 is disposed on the mouth and the nose of the target 2. The air supplying device 142 is a high pressure gas cylinder.

In the present embodiment, the processing device 16 opens the valve 144 to allow the target 2 breathing when the sleep apnea condition does not occur. Further, the processing device 16 closes the valve 144 to control the high pressure gas cylinder to transmit the airflow 17 to the mouth and the nose of the target 2 through the air providing mask 140 when the sleep apnea condition occurs.

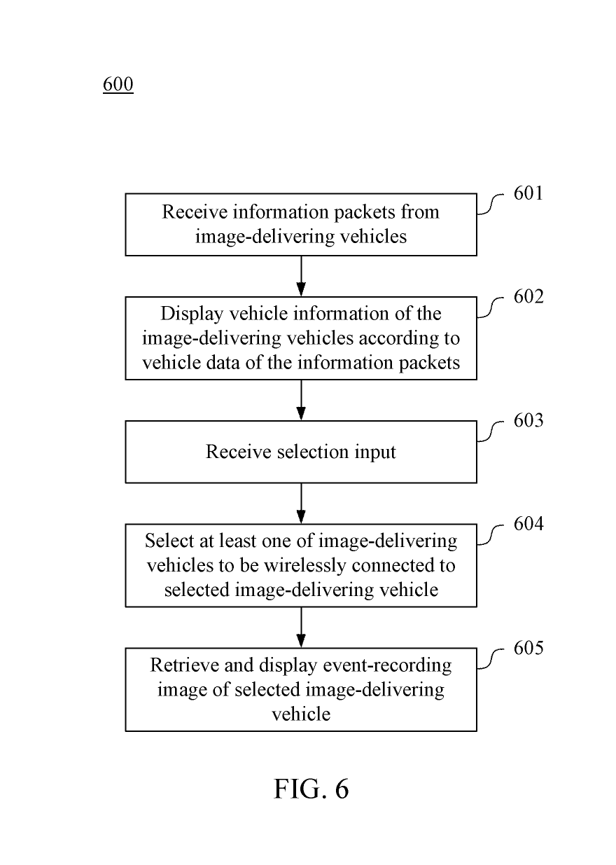

FIG. 6 is a flow chart of a telematics communication method 600 in an embodiment of the present invention. The telematics communication method 600 is used in the telematics communication system 1 illustrated in FIG. 1, especially the image-receiving vehicle 12. The telematics communication method 600 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 601, the communication module 300 receives the information packets 13A and 13B from the image-delivering vehicles 10A and 10B.

In step 602, the processing module 304 retrieves the information packets 13A and 13B from the communication module 300 to control the display module 302 to display the vehicle information of each of the image-delivering vehicles 10A and 10B.

In step 603, the input module 306 receives the selection input 303.

In step 604, the processing module 304 selects at least one of the image-delivering vehicles 10A and 10B according to the selection input 303 to be wirelessly connected to the selected image-delivering vehicle (e.g. the image-delivering vehicle 10A).

In step 605, the processing module 304 retrieves the event-recording image 11A from the selected image-delivering vehicle (e.g. the image-delivering vehicle 10A) to display the event-recording image 11A on the display module 302.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A vehicle equipped with a telematics technology, comprising:
a communication module to receive information packets that comprise vehicle data and service data from a plurality of image-delivering vehicles;
a display module;
a processing module electrically connected to the communication module and the display module to retrieve the information packets from the communication module to control the display module to display vehicle information of each of the image-delivering vehicles accordingly; and
an input module electrically connected to the processing module to receive a selection input;
wherein the processing module selects at least one of the image-delivering vehicles according to the selection input to be wirelessly connected to a selected image-delivering vehicle and retrieves an event-recording image from the selected image-delivering vehicle to display the event-recording image on the display module.

2. The vehicle of claim 1, wherein the communication module receives the information packets through a default broadcast or multicast internet protocol frequency band under an internet protocol (IP) mode.

3. The vehicle of claim 1, wherein the communication module receives the information packets under an AD HOC mode, a WiFi direct mode or one of the other non internet protocol modes.

4. The vehicle of claim 1, wherein the vehicle data comprises an identification code and a position coordinate corresponding to at least one of the image-delivering vehicles.

5. The vehicle of claim 4, further comprising a positioning module to generate a self position coordinate of the vehicle, wherein the processing module controls the display module to display the vehicle information according to the identification code, the position coordinate and the self position coordinate, wherein the vehicle information comprises a relative position relative to the vehicle and the identification code corresponding to each of the image-delivering vehicles.

6. The vehicle of claim 1, wherein the service data comprises a service type, a service name, a service code, a service description string, a descriptive file source URL or a combination of the above of at least one of the corresponding image-delivering vehicles.

7. The vehicle of claim 6, wherein the processing module retrieves the service description string or retrieves a descriptive file according to the descriptive file source URL from the selected image-delivering vehicle to perform a coordination process to coordinate an image reception and transmission mode according to a content of the service description string or the descriptive file;
wherein the processing module further establish a network connection according to the coordinated image reception and transmission mode to retrieve the event-recording image from the selected image-delivering vehicle.

8. The vehicle of claim 1, wherein the input module is a speech recognition module to receive a speech selection input to perform a recognition process and obtain the selection input after the recognition process.

9. The vehicle of claim 1, wherein the input module and the display module are integrated as a touch display module to receive a touch selection input as the selection input.

10. The vehicle of claim 1, further comprising a self image-retrieving module to perform image-retrieving and generate a self event-recording image, wherein the processing module controls the display mode to display the self event-recording image and the event-recording image from at least one of the image-delivering vehicles by using a plurality independent frames, a plurality frames in a picture in picture mode or a single mixed frame.

11. A telematics communication method used in a vehicle equipped with a telematics technology, the telematics communication method comprises:
receiving information packets that comprise vehicle data and service data from a plurality of image-delivering vehicles by a communication module;
retrieving the information packets from the communication module by a processing module to control a display module to display vehicle information of each of the image-delivering vehicles accordingly;
receiving a selection input by an input module;
selecting at least one of the image-delivering vehicles by the processing module according to the selection input to be wirelessly connected to a selected image-delivering vehicle; and
retrieving an event-recording image from the selected image-delivering vehicle to display the event-recording image on the display module.

12. The telematics communication method in claim 11, wherein the vehicle data comprises an identification code and a position coordinate corresponding to at least one of the image-delivering vehicles.

13. The telematics communication method in claim 12, wherein the vehicle further comprises a positioning module, and the telematics communication method further comprises:
generating a self position coordinate of the vehicle by the positioning module;
controlling the display module to display the vehicle information according to the identification code, the position coordinate and the self position coordinate by the processing module, wherein the vehicle information comprises a relative position relative to the vehicle and the identification code corresponding to each of the image-delivering vehicles.

14. The telematics communication method in claim 11, wherein the service data comprises a service type, a service name, a service code, a service description string, a descriptive file source URL or a combination of the above of at least one of the corresponding image-delivering vehicles.

15. The telematics communication method in claim 14, further comprising:
retrieving the service description string or retrieving a descriptive file according to the descriptive file source URL from the selected image-delivering vehicle by the processing module; and
performing a coordination process to coordinate an image reception and transmission mode by the processing module according to a content of the service description string or the descriptive file to establish a network connection according to the coordinated image reception and transmission mode to retrieve the event-recording image from the selected image-delivering vehicle.

16. The telematics communication method in claim 11, wherein the input module is a speech recognition module to receive a speech selection input to perform a recognition process and obtain the selection input after the recognition process.

17. The telematics communication method in claim 11, wherein the input module and the display module are integrated as a touch display module to receive a touch selection input as the selection input.

18. The telematics communication method in claim 11, wherein the vehicle further comprises a self image-retrieving module, and the telematics communication method further comprises:
performing image-retrieving by the self image-retrieving module to generate a self event-recording image; and
controlling the display mode to display the self event-recording image and the event-recording image from at least one of the image-delivering vehicles by the processing module by using a plurality independent frames, a plurality frames in a picture in picture mode or a single mixed frame.

19. A telematics communication system comprising:
a plurality of image-delivering vehicles to broadcast information packets and perform image-retrieving to generate an event-recording image, wherein the information packets comprise vehicle data and service data; and
an image-receiving vehicle comprising:
a communication module to receive information packets from a plurality of image-delivering vehicles;
a display module;
a processing module electrically connected to the communication module and the display module to retrieve the information packets from the communication module to control the display module to display vehicle information of each of the image-delivering vehicles accordingly; and
an input module electrically connected to the processing module to receive a selection input;
wherein the processing module selects at least one of the image-delivering vehicles according to the selection input to be wirelessly connected to a selected image-delivering vehicle and retrieves the event-recording image from the selected image-delivering vehicle to display the event-recording image on the display module.

20. The telematics communication system of claim 19, wherein each of the image-delivering vehicles comprises:
an image-delivering vehicle image-retrieving module to generate the event-recording image;
an image-delivering vehicle storage module to store the event-recording image;
an image-delivering vehicle positioning module to generate a position coordinate of one of the image-delivering vehicles comprised in the vehicle data; and
an image-delivering vehicle communication module to broadcast the information packets and allow the image-receiving vehicle retrieving the event-recording image from the image-delivering vehicle storage module through the image-delivering vehicle communication module.
